(19) United States
(12) Patent Application Publication
(10) Pub. No.: US 2010/0172466 A1
(43) Pub. Date: Jul. 8, 2010

(54) RADIATION DETECTOR WITH COUNTING ELECTRONICS

(75) Inventors: Christoph Herrmann, Aachen (DE); Roger Steadman, Aachen (DE); Guenter Zeitler, Aachen (DE); Christian Baeumer, Aachen (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/376,854

(22) PCT Filed: Aug. 10, 2007
(86) PCT No.: PCT/IB07/53182

§ 371 Date: Feb. 9, 2009

(30) Foreign Application Priority Data
Aug. 14, 2006 (EP) 06118878.5

(51) Int. Cl. H05G 1/60; G01T 1/17; G01T 1/18

(52) U.S. Cl. 378/19; 250/394

(57) ABSTRACT

The invention relates to a radiation detector, particularly an X-ray detector (100), comprising a counting circuitry (10, 20, 30) for counting electrical pulses generated by the (sub-)pixels (2) of the detector. In the counting circuitry, the results counted by a fast counting stage (10) are at intervals transferred to a slow counting stage (20). The fast counting stage (10) may for example comprise a fast counter (111) with a low bit-depth operating as a frequency divider in front of a slow counter (121) of high bit-depth in the slow counting stage (20). The counting circuitry (10, 20, 30) can optionally be fed via a multiplexer (4) with the signals of several (sub-)pixels (2). Furthermore, the pixels (1, 2) of the radiation device may optionally deliver energy resolved pulses.

The invention relates to a radiation detector comprising sensitive units that generate electrical pulses and a counting circuitry for counting said pulses. Moreover, it relates to an X-ray device comprising such a detector.

Radiation detectors are used to determine the amount of radiation, particularly X-radiation or gamma radiation, hitting the “pixels” of the detector. According to a particular measuring principle that provides a high accuracy, the number of photons impinging on the pixels is digitally counted, which may optionally be done in an energy resolved way. In this respect it is known from the WO 2004/8488A2 to couple a pair of pixels via an intermediate logic to a single counter in order to reduce the number of counters on the detector chip.

Based on this situation it was an object of the present invention to provide alternative designs for a radiation detector with a counting circuitry. In particular, designs are desired that require only comparatively simple, cost-effective components for counting electrical pulses.

This object is achieved by a radiation detector according to claim 1 and by an X-ray device according to claim 10. Preferred embodiments are disclosed in the dependent claims.

The radiation detector according to the present invention may in principle serve for the detection of any kind of radiation that can be measured via countable electrical pulses, including e.g. acoustical radiation. In typical applications, the detector will be used to measure photons of electromagnetic radiation, particularly X-ray or γ photons. The radiation detector comprises sensitive units that generate electrical pulses, for example current or voltage pulses, wherein the term “pulse” shall denote any kind of signal that has a definite, recognizable shape (e.g. of a single peak). The sensitive units are typically arranged in a matrix pattern as “pixels” or “sub-pixels”, and each pulse typically represents one absorbed photon of radiation. The radiation detector further comprises a counting circuitry to which the aforementioned electrical pulses are supplied and that is adapted to count these pulses. In the counting circuitry, the following components are connected in series:

a) A fast counting stage with a reaction time that is fast enough to manage a given maximal pulse rate, wherein said fast counting stage is fed with the electrical pulses generated by one or more of the sensitive units. The “reaction time” of the counting stage shall denote the time for which the counting stage is blocked by the processing (i.e. counting) of one pulse (if a second pulse arrives during the reaction time, i.e. while the previous pulse is still processed, the second pulse will typically be lost). It is therefore important that the reaction time of the first counting stage is small enough to allow the processing of all provided pulses with minimum loss. In the proposed design, this is guaranteed as long as the actual pulse rate is smaller than the given maximal pulse rate, which typically has a value between 0.2×10⁶ and 50×10⁶ pulses per second.

b) A slow counting stage with a longer reaction time than the reaction time of the fast counting stage, wherein the slow counting stage and the fast counting stage are coupled in such a way that counting results of the fast counting stage are transferred to the slow counting stage at a rate that is slower than the maximal pulse rate. It should be noted that the terms “fast” and “slow” have only a relative meaning here as they refer to the durations of the reaction times.

The described radiation detector allows a comparatively compact and cost-effective design of the counting circuitry as this is split into a fast and a slow stage. The fast components can have only a relatively small bit-depth, as their results are at intervals transferred to the slow counting stage. The slow counting stage, on the contrary, has a larger bit-depth (it must store the complete count), but it can be realized in a more simple way with respect to operating speed.

There are various possibilities to realize a counting circuitry in accordance with the above principles. In a first particular embodiment of the invention, the fast counting stage comprises a fast counter that is operated as a frequency divider for the slow counting stage. As usual, the term “counter” denotes an electrical component that counts electrical pulses provided at its input and that represents the number of counted pulses as a bit string. Such a counter can be used as a frequency divider, if for example the bit string represents the binary number of the counted pulses and if only the highest bit of that number is passed on to the next stage. A fast counter with just one bit will therefore cut the rate of the incoming electrical pulses in half, and the associated counters in the slow counting stage can be designed correspondingly slower. Of course, the effect of the frequency division has to be taken into account when the results of the slow counting stage are interpreted.

In a further development of the aforementioned embodiment, the fast counting stage comprises a bypass logic for selectively bypassing the fast counter, i.e. for guiding the electrical pulses provided by the sensitive units directly and without an intermediate frequency division to the slow counting stage. Such a bypassing can for example adaptively be switched on as long as the rate of the incoming pulses does not exceed the rate that can be managed by the slow counting stage.

In a second particular embodiment of the invention, the fast counting stage comprises a plurality of fast counters that are provided with inputs from different sensitive units, and the slow counting stage comprises an accumulator that is incremented by the sum of the values stored in the fast counters each time a trigger signal is given. In this design, each fast counter counts the number of pulses delivered by one (or more) associated sensitive unit(s), i.e. it must be able to process pulses up to the maximal pulse rate. The fast counters can nevertheless be kept simple if they have a comparatively low bit depth (e.g. 4 to 8 bits), which is sufficient as their values are transferred to the accumulator at relatively short time intervals. The accumulator must of course have a larger bit depth, but it needs not to be a high-speed component.

According to a further development of the aforementioned embodiment, the counting circuitry comprises a frame synchronization module that resets the fast counters each time a trigger signal is given. The fast counters will therefore restart their counting at zero after each transfer of their previous values to the accumulator. The frame synchronization module may optionally be adapted to generate the trigger signal, too.

In another further development of the invention, the counting circuitry comprises a multiplexer for coupling a plurality of sensitive units to a single input of the fast counting stage. The multiplexer allows that several sensitive units share one fast counter, which obviously reduces the hardware effort accordingly.

Latches may optionally be inserted in front of and/or behind the fast counting stage. Similarly, latches may be inserted in front of and/or behind the slow counting stage, too. The latches allow to hold signals (bit values) until they can be processed by a following stage. Moreover, latches have the advantage to decouple consecutive components and to prevent undesired interferences. A latch in front of a counter further allows to use a simple synchronous counter as the asynchronously (i.e. randomly) arriving electrical pulses are preserved in the latch until they are counted.

The radiation detector may further comprise a discrimination logic for discriminating radiation photons from different (overlapping or distinct) energy windows and for generating associated electrical pulses that are counted separately. In this case, spectrally or energy resolved measurements of the incident radiation are possible, which provides a plenty of additional information.

The two-stage design of the counting circuitry can be restricted to regions of the detector area where it is necessary for managing high radiation fluxes. The radiation detector may thus optionally comprise sensitive units that are coupled to a counting circuitry which has a slow counting stage only. In the X-ray detector of a CT (Computed Tomography) scanner, this may for example be central areas of the detector which typically receive a reduced flux due to an absorption by the examined objects.

The invention further relates to an X-ray device, particularly a CT scanner, comprising an X-ray source and an X-ray detector as it was described above.

These and other aspects of the invention will be apparent from and elucidated with reference to the embodiment(s) described hereinafter. These embodiments will be described by way of example with the help of the accompanying drawings in which:

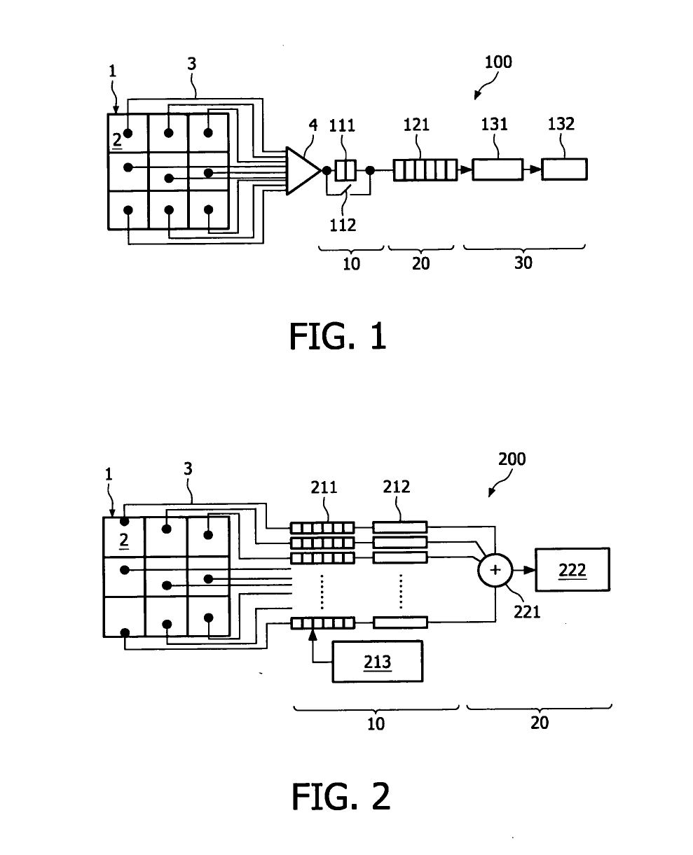

FIG. 1 shows schematically a radiation detector according to a first embodiment of the present invention, wherein a frequency divider is arranged in front of a slow counting stage;

FIG. 2 shows schematically a radiation detector according to a second embodiment of the present invention, wherein fast counters are coupled to an accumulator;

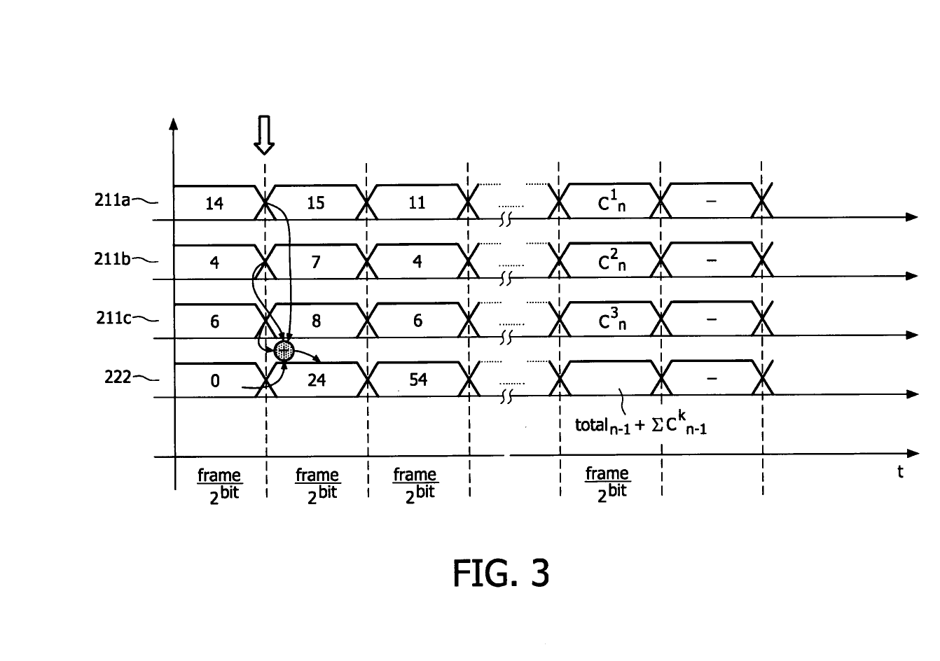

FIG. 3 shows an exemplary temporal sequence of activity of the counters and the accumulator for the detector of FIG. 2.

Like reference numbers or numbers differing by integer multiples of 100 refer in the Figures to identical or similar components. While the embodiments shown in the Figures are related to the application of the present invention to an X-ray detector for a CT scanner, the invention is not limited to this case in any way.

FIG. 1 shows one pixel 1 of the total detector area which usually comprises several thousands of such pixels. Due to the high X-ray photon flux of typically 10⁹/mm²s, it is necessary to structure each pixel 1 of a CT detector in several sub-pixels 2 in order to reduce the count rate seen in each sub-pixel. For instance, a CT pixel of 1 mm×1 mm would have to be sub-structured into 100 sub-pixels of 100 μm×100 μm each. Further, there are several ways to subdivide the sensitive volume of the detector pixel of typically 1 mm×1 mm×(1-3) mm (the thickness depends on the properties of the sensor material used) into sub-pixels which can have equal or dissimilar volume. The sub-pixel counts have then to be summed up within each pixel, since it is virtually impossible (due to limited data rate as well as limited read-out lines) to read out all sub-pixel counts separately and sum them up after read-out. A separate addition component within each pixel will however consume quite some pixel space; in addition it can then be problematic to use m-sequence feedback shift-registers, which are known as very chip-area-efficient counter implementations (cf. Fischer, “An area efficient 128 channel counter chip”, Nucl. Instr. and Meth. in Physics Research A, 378 (1996)), to build the counters: Since the m-sequence counter output is a bit string, which has to be mapped to the corresponding count value, it is necessary to first map these bit strings to the count value, and then add the count values. In case of an implementation in the pixel, also this mapping functionality has to be implemented, which again costs valuable chip area.

The problem becomes even more severe (in terms of required chip area), if each pixel is to be able to count photons of different energies separately, i.e. if the pixel can “sort” the photons according to their energies based on a number of energy bins. In this case, in the simplest approach, each sub-pixel 2 contains several discriminators. Only one energy threshold is used to define an energy bin. The discriminator with the lowest threshold is used to distinguish photons from noise. Each discriminator's output is connected to a separate counter. Then, a counter counts the number of photons, the energy of which exceeds the threshold of the discriminator, which is connected to this counter. Hence, a photon, the energy of which is higher than the highest threshold, will be counted by all counters (this amounts to a single threshold counting with overlapping energy windows). In a more sophisticated implementation (cf. P. Fischer, H. Helmich, M. Lindner, N. Wermes, L. Blanquart, “A photon counting pixel chip with energy windowing”, IEEE Trans Nucl Sci, Vol. 47, No. 3, (2000)), there may be additional logic which makes sure that only the very counter is incremented, which belongs to the discriminator, the threshold of which is the highest, which the energy of the photon to be counted exceeds (this amounts to a counting in distinctive energy windows). Given e.g. there are 100 sub-pixels and four energy bins per pixel (which also means four energy bins per sub-pixel), it would be necessary to add up the counter values of the 100 sub-pixels for each energy-bin separately.

In order to address the problems mentioned above, a way is proposed here to either avoid an adder to sum up the number of counts within an energy bin or to provide an area/speed efficient implementation of a counting scheme.

In a first, optional aspect of the proposed designs, several sub-pixels 2 are connected via lines 3 and a logic block 4 to a single counting circuitry (that is composed of several stages 10, 20, 30; it should be noted that FIG. 1 shows schematics for sub-pixels 2 with a certain common energy bin—if each sub-pixel has more than one energy bin, the arrangement has to be extended according to the number of energy bins). The counting circuitry can inherently count the events generated in all sub-pixels 2 of a pixel 1 (or a sub-set of sub-pixels) in a certain energy bin, so that the number of counters is considerably reduced, and valuable chip area is saved in comparison to a design with one counter for each sub-pixel. As a prerequisite the counting circuitry has to be fast enough, i.e. has to be able to cope with the count rate resulting for the associated energy bin. The logic block 4 is in charge of processing the count events of the different sub-pixels 2 in such a way that they result in the correct count value: In the particular case considered, the logic block may be a (e.g. analog) multiplexer 4, or a “wired-or” implementation.

It may be advantageous to also choose the energy bins in such a way that, for the highest count rates, which a pixel can see (i.e. usually the photon rate in a direct beam), the number of counts (per measurement interval) within each energy bin is approximately the same, so that the counters can be of similar length in bits. Such an approach is, however, only possible for “counting in distinctive energy windows”.

The counting circuitry of FIG. 1 comprises a “slow counting stage 20” with a normal counter 121 having a higher number of bits (e.g. 16 bit) for counting the multiplexed electrical pulses provided by the multiplexer 4. If this normal counter 121 would be used alone, it might happen that the count rate becomes higher than what the counter 121 can handle. To prevent this case, a pre-counter 111 is inserted in a first “fast counting stage” 10 in front of the normal counter 121, wherein said pre-counter 111 is much faster than the single normal 16-bit-counter 121, but has only a very low number of bits (e.g. only one or two). The pre-counter 111 will then act as a “frequency divider”. A 1-bit pre-counter 111 will for example only generate a counting impulse at its output for the single normal counter 121, if it has seen two counts from the multiplexed sub-pixels 2 at its input.

In an output stage 30 of the counting circuitry, the value of the counter 121 is passed, on to a latch 131 and from there to a digital read-out circuit 132 as it is known in the state of the art. If the pre-counter 111 is active in the fast counting stage 10, the digital read-out data will have to be “corrected” for this fact, i.e. the read-out count value has to be multiplied by the factor, by which the frequency is reduced, in order to get an estimate of the correct number of counts.

As indicated by a bypass-switch 112, it is possible to adaptively connect or disconnect the pre-counter 111 depending on the count rate which is seen by the detector.

A somewhat simpler design is achieved if the pixels are configured depending on their position on the CT detector area. Detector pixels in the edges of the banana-shaped CT detector area, which often see the direct beam, might for example always use a pre-counter, while those in the center of the detector area might never use it (this approach has however to take into account that in a full body scan the center pixels see a direct beam when the beam meets the patient's legs, unless a particular filtering material is positioned between the legs).

The number of sub-pixels 2 clustered to a single counting circuitry has to be chosen such (i.e. small enough) that the counting circuitry can cope with the maximum count rate in the associated area and energy bin. In case that two counting events take place in the same instant, it is very likely that the counting circuitry only accounts for one of the pulses. This may however be uncritical since the probability that at low count rates two counts take place at the same instant is very low, and since the loss of a few counts due to simultaneous events may not be significant at high count-rates or correction schemes according to dead-time models can be applied.

FIG. 2 shows a second embodiment of a radiation detector 200 that solves the aforementioned problems with a slightly more complicated structure which still provides benefits in both area and speed. The basic idea of this embodiment is to include in the fast counting stage 10 fast and very compact (asynchronous) counters 211 with a low bit-depth at sub-pixel level for a certain energy bin implemented at pixel level. The values of these counters 211 are then consecutively

latched in latches 212,

added in an adder 221 at periodic time intervals (“sub-frames”), and

stored onto an accumulator 222 or macro-latch.

The mentioned time intervals depend on the bit-depth of the fast counters 211 (e.g. 4 bit). Every time the values are transferred, the counters are reset to 0 and a new sub-frame may start. The reset phase should be shorter than the maximum count rate to avoid that any events are not accounted for.

The latches 212 placed behind the counters 211 represent a “synchronization step” necessary to ensure that the addition does not disturb the counting operation. The addition is preferably done at regular intervals, which are so short that the sub-pixel counters 211 do not overflow during the interval.

Synchronous counters (i.e. counters which only count at clock cycles) may also be applicable. Since the charge pulses from the (sub-)pixels 1, 2 can occur at any time, the counting pre-amplifier's discriminator (not shown) can indicate that its threshold was exceeded due to a charge pulse also between clock flanks, at which counting happens. A 1-bit latch is needed in this case between the discriminator and the synchronous counter in order to make sure that a threshold passage is still visible at the next clock flank which triggers counting.

In the accumulator 222, the values of all counters 211 are stored in addition to the previous state of the accumulator. This is illustrated in the signal diagram of FIG. 3 for the example of three counters 211a, 211b, 211c.

In the detector of FIG. 2, a pre-counter like the counter 111 of FIG. 1 can also be used if the photon rate is higher than what the counters 211 can process.

The described type of detector is primarily of interest in X-ray and CT imaging systems, since it allows for improving image quality via energy coded processing methods in the sense that structures can be made visible (e.g. potentially even soft-plaque), which are invisible if a conventional integrating X-ray detector is used.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. A radiation detector, particularly an X-ray detector, comprising sensitive units that generate electrical pulses and a counting circuitry for counting said pulses, wherein the counting circuitry comprises:
a) a fast counting stage with a reaction time that is fast enough to manage a given maximal pulse rate and with a plurality of fast counters that are provided with inputs from different sensitive units;
b) a slow counting stage with a longer reaction time than the fast counting stage and with an accumulator, wherein the slow counting stage and the fast counting stage are coupled in such a way that counting results of the fast counting stage are transferred to the slow counting stage at a rate lower than the maximal pulse rate, and wherein the accumulator is incremented upon a trigger signal by the sum of the values of the fast counters.

2. The radiation detector according to claim 1,
wherein the fast counting stage comprises a fast counter operating as a frequency divider for the slow counting stage.

3. The radiation detector according to claim 2,
wherein the fast counting stage comprises a bypass-logic for selectively bypassing the fast counter.

4. The radiation detector according to claim 1,
wherein the fast counting stage comprises a plurality of fast counters of the fast counting stage have a bit depth between 4 and 8 bits.

5. The radiation detector according to claim 4,
wherein it comprises a frame synchronization module that resets the fast counters upon the trigger signal.

6. The radiation detector according to claim 1,
wherein it comprises a multiplexer for coupling a plurality of sensitive units to the input of the fast counting stage.

7. The radiation detector according to claim 1,
wherein it comprises latches (131, 212) in front of and/or behind the fast counting stage and/or the slow counting stage.

8. The radiation detector according to claim 1,
wherein it comprises a discrimination logic for discriminating radiation photons of different energy and for generating associated electrical pulses that are counted separately for different energy windows.

9. The radiation detector according to claim 1,
wherein it comprises sensitive units coupled to a counting circuitry with a slow counting stage only.

10. An X-ray device, particularly a CT scanner, comprising an X-ray source and an X-ray detector according to claim 1.
